(19) United States
(12) Patent Application Publication
(10) Pub. No.: US 2026/0045473 A1
(43) Pub. Date: Feb. 12, 2026

(54) ROLL-TO-ROLL, STEPWISE EXTRUSION PROCESS USING SEMI-DRY POWDER FOR MANUFACTURING A FREE-STANDING ACTIVE MATERIAL LAYER FOR A BATTERY ELECTRODE

(71) Applicant: GM GLOBAL TECHNOLOGY OPERATIONS LLC, Detroit, MI (US)

(72) Inventors: Dewen KONG, Shanghai (CN); Ming WANG, Sterling Heights, MI (US); Xiaowei YU, Farmington Hills, MI (US); Yong LU, Shanghai (CN); Haijing LIU, Shanghai (CN)

(21) Appl. No.: 18/895,524

(22) Filed: Sep. 25, 2024

(30) Foreign Application Priority Data
Aug. 6, 2024 (CN) 2024110706503

(51) Int. Cl. H01M 4/04; H01M 4/62

(52) U.S. Cl. CPC H01M 4/0411; H01M 4/622

(57) ABSTRACT

A method for manufacturing a cathode electrode of a battery cell includes providing a dry powder mixture including an active material, a conductive additive, and a binder to a first extruder; mixing the active material, the conductive additive, and the binder in the first extruder; partially fibrillating the binder in the first extruder; supplying an admixture from the first extruder to a first input of a second extruder; supplying a solvent to a second input of the second extruder; mixing the active material, the conductive additive, the binder, and the solvent in the second extruder; fibrillating the binder in the second extruder; and forming an active material layer using an extrudate die arranged at an output of the second extruder.

### CROSS-REFERENCE TO RELATED APPLICATIONS

This application claims the benefit of Chinese Patent Application No. 202411070650.3 filed on Aug. 6, 2024. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to a method for manufacturing active material layers and/or electrodes for battery cells using a semi-dry powder.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

Battery cells include cathode electrodes, anode electrodes, and separators. The cathode electrodes include a cathode active material layer (including cathode active material) arranged on a cathode current collector. The anode electrodes include an anode active material layer (including anode active material) arranged on an anode current collector.

### SUMMARY

A method for manufacturing a cathode electrode of a battery cell includes providing a dry powder mixture including an active material, a conductive additive, and a binder to a first extruder; mixing the active material, the conductive additive, and the binder in the first extruder; partially fibrillating the binder in the first extruder; supplying an admixture from the first extruder to a first input of a second extruder; supplying a solvent to a second input of the second extruder; mixing the active material, the conductive additive, the binder, and the solvent in the second extruder; fibrillating the binder in the second extruder; and forming an active material layer using an extrudate die arranged at an output of the second extruder.

In other features, a first temperature of the first extruder is in a range from 19° C. to 70° C. and a second temperature of the second extruder is greater than 70° C.

In other features, the binder is selected from a group consisting of polytetrafluoroethylene (PTFE), fluorinated ethylene propylene (FEP), perfluoroalkoxy alkane (PFA), ethylene tetrafluoroethylene (ETFE), polyethylene (PE), and combinations thereof. A particle size of the binder is in a range from 1 μm to 1000 μm. A particle size of the binder is in a range from 1 μm to 50 μm.

In other features, the solvent is selected from a group consisting of alcohol, ester, and combinations thereof. The solvent comprises 5 wt % to 20 wt % of the admixture. Partially fibrillating the binder in the first extruder comprises fibrillating the binder in a range from 10% to 40%. Fibrillating the binder in the second extruder comprises fibrillating the binder greater than 90%.

In other features, the second temperature of the admixture in the second extruder is less than 150° C. The method includes outputting the active material layer onto a supporting film. The method includes outputting the active material layer as a freestanding film. The method includes pressing and heating the active material layer and laminating the active material layer onto a current collector.

A method for manufacturing a cathode electrode of a battery cell includes providing a dry powder mixture including a cathode active material, a conductive additive, and a binder to a first inlet of an extruder; mixing the cathode active material, the conductive additive, and the binder in a first portion of the extruder; partially fibrillating the binder in the first portion of the extruder; supplying a first solvent to a second portion of the extruder; further partially fibrillating the binder in the second portion of the extruder; supplying a second solvent to a third portion of the extruder; fibrillating the binder in the third portion of the extruder; and forming an active material layer using a slotted die arranged at an output of the third portion of the extruder.

In other features, the binder is selected from a group consisting of polytetrafluoroethylene (PTFE), fluorinated ethylene propylene (FEP), perfluoroalkoxy alkane (PFA), ethylene tetrafluoroethylene (ETFE), polyethylene (PE), and/or mixtures thereof. A particle size of the binder is in a range from 1 μm to 1000 μm.

In other features, the first solvent is selected from a group consisting of alcohol, ester, and combinations thereof. The first solvent comprises 5 wt % to 10 wt % of a mixture in the second portion of the extruder. The second solvent is selected from a group consisting of alcohol, ester, and combinations thereof. The second solvent comprises 5 wt % to 10 wt % of a mixture in the third portion of the extruder.

In other features, the method includes partially fibrillating the binder in the first portion of the extruder comprises fibrillating the binder in a range from 20% to 40%, partially fibrillating the binder in the second portion of the extruder comprises fibrillating the binder in a range from 60% to 80%, and fibrillating the binder in the third portion of the extruder comprises fibrillating the binder greater than 90%.

In other features, a temperature of the extruder is greater than 70° C. and less than 150° C. The method includes outputting the active material layer onto a supporting film. The method includes outputting the active material layer as a freestanding film. The method includes pressing and heating the active material layer. The method includes laminating the active material layer onto a current collector.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross section of an example of a battery cell including C cathode electrodes, A anode electrodes, and S separators according to the present disclosure;

FIGS. 2A and 2B are side cross sections of examples of a cathode electrode and an anode electrode, respectively, according to the present disclosure;

FIG. 3 is a functional block diagram of an example of a stepwise extrusion process for manufacturing a self-standing active material layer according to the present disclosure;

FIG. 4 is a functional block diagram of another example of a stepwise extrusion process for manufacturing a self-standing active material layer according to the present disclosure;

FIG. 5 is a functional block diagram of an example of rolling and heating of the active material layer according to the present disclosure; and

FIG. 6 is a functional block diagram illustrating an example of laminating the active material layer onto a current collector according to the present disclosure.

In the drawings, reference numbers may be reused to identify similar and/or identical elements.

### DETAILED DESCRIPTION

While battery cells according to the present disclosure are shown in the context of electric vehicles, the battery cells can be used in stationary applications and/or other applications.

The present disclosure relates to a roll-to-roll (R2R) process for fabricating an active material layer for anode and/or cathode electrodes of a battery cell using a semi-dry powder. In some examples, a stepwise extrusion processes is used to fabricate a thick electrode utilizing a dry powder including cathode or anode active material, a conductive additive (such as carbon), a binder (such as polytetrafluoroethylene (PTFE)), and a manufacturing friendly solvent (such as alcohol) as a processing solvent media.

In some examples, the dry powder is actively premixed in a first extruder to uniformly mix the components and partially fibrillate the binder. The admixture from the first extruder is supplied to an inlet of a second extruder. A processing solvent is also added to the second extruder and the binder is further fibrillated. In some examples, the second extruder outputs a freestanding active material layer with a film thickness controlled by a die attached to the output of the second extruder. In some examples, the second extruder outputs an active material layer onto a supporting film (such as polyester (PET) film).

Referring now to FIG. 1, a battery cell 10 includes C cathode electrodes 20, A anode electrodes 40, and S separators 32 arranged in a predetermined sequence in a battery cell stack 12, where C, S and A are integers greater than zero. The battery cell stack 12 is arranged in an enclosure 50. Liquid electrolyte 52 is added to the enclosure 50.

The C cathode electrodes 20-1, 20-2, . . . , and 20-C include a cathode active material layer 24 arranged on one or both sides of a cathode current collector 26. The A anode electrodes 40-1, 40-2, . . . , and 40-A include anode active material layers 42 arranged on one or both sides of the anode current collectors 46. The S separators 32-1, 32-2, . . . , and 32-S are arranged between the C cathode electrodes 20 and the A anode electrodes 40.

In some examples, the A anode electrodes 40 and the C cathode electrodes 20 exchange lithium ions during charging/discharging. In some examples, the cathode active material layers 24 and/or the anode active material layers 42 comprise coatings including one or more active materials, one or more conductive additives, and/or one or more binder materials that are cast or applied onto one or both sides of the current collectors 26 and/or 46, respectively.

In some examples, the cathode current collector 26 and/or the anode current collector 46 comprise metal foil, metal mesh, perforated metal, 3 dimensional (3D) metal foam, and/or expanded metal. In some examples, the current collectors are made of one or more materials selected from a group consisting of copper, stainless steel, brass, bronze, zinc, aluminum, and/or alloys thereof. External tabs 28 and 48 are connected to the current collectors of the cathode electrodes and anode electrodes, respectively, and can be arranged on the same or different sides of the battery cell stack 12. The external tabs 28 and 48 are connected to terminals of the battery cells.

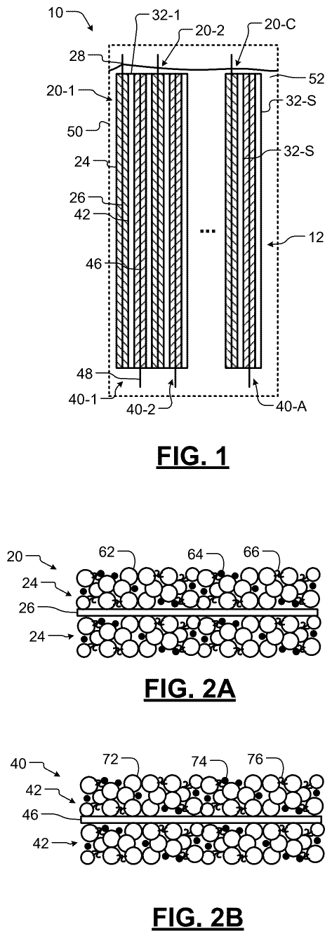

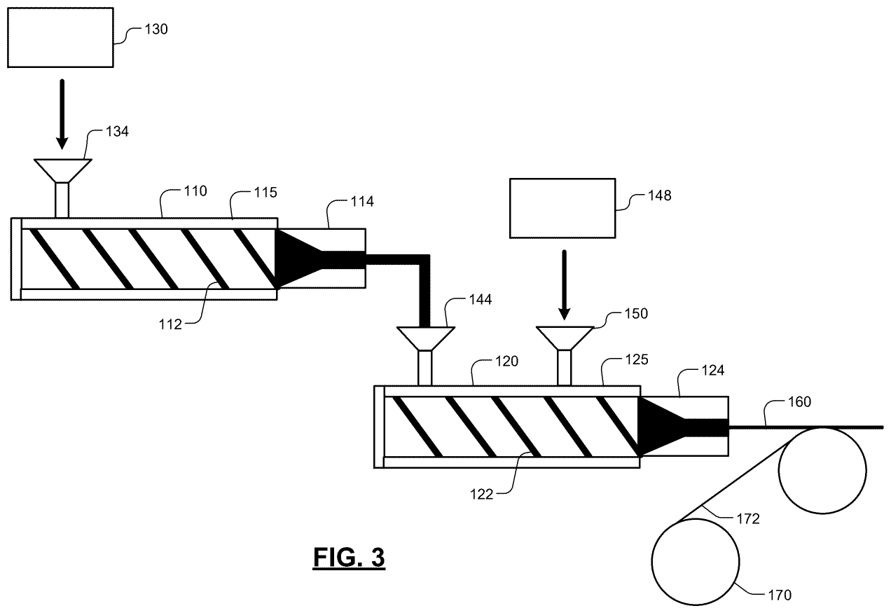

Referring now to FIGS. 2A and 2B, examples of the electrodes are shown. In FIG. 2A, one of the C cathode electrodes 20 is shown in more detail. The cathode active material layer 24 includes a cathode active material 62, a conductive additive 64, and a binder 66. In FIG. 2B, one of the A anode electrodes 40 is shown in more detail. The anode active material layer 42 includes an anode active material 72, a conductive additive 74, and a binder 76.

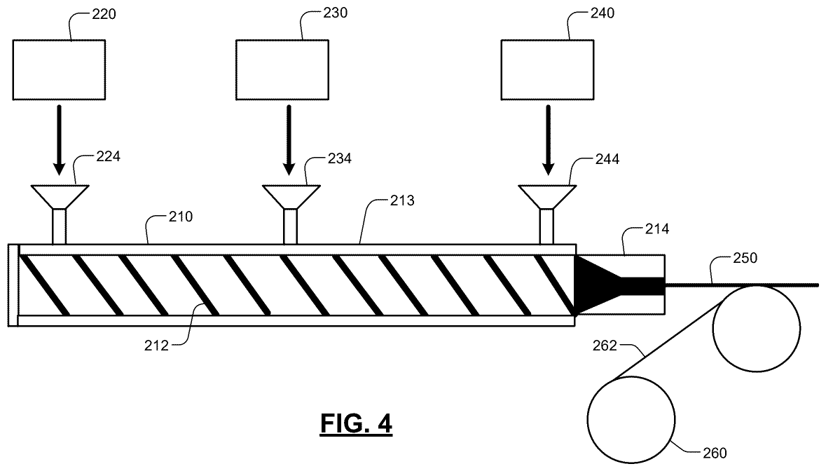

Referring now to FIG. 3, a stepwise extrusion process using two or more extruders connected in series is shown. A first extruder 110 includes a screw 112 rotatably arranged in an enclosure 115. A die 114 may be arranged at the outlet of the first extruder 110. An admixture output by the first extruder 110 is fed to a second extruder 120 including a screw 122 arranged in an enclosure 125. A die 124 (such as a slotted die) is arranged at the outlet of the second extruder 120.

A dry powder 130 including a mixture of cathode or anode active material, a conductive filler, and a binder is fed to an inlet 134 of the first extruder 110. The screw 112 of the first extruder 110 rotates within the enclosure 115 to mix and/or shear the dry powder. The first extruder 110 at least partially fibrillates the binder.

The admixture output by the first extruder 110 is fed to a first inlet 144 of the second extruder 120. A liquid feed 148 supplies solvent to a second inlet 150 of the second extruder 120. In some examples, the solvent is selected from a group consisting of alcohol, ester, and combinations thereof. The screw 122 of the second extruder 120 rotates within the enclosure 125 to mix and further shear the dry powder. The second extruder 120 further fibrillates the binder. The die 124 of the second extruder 120 outputs an active material layer 160 as a self-standing film or the active material layer 160 is output onto a supporting film 172 supplied by a roll 170.

In some examples, the first extruder 110 fibrillates the binder in a range from 10% to 40%. In some examples, the temperature of the mixture in the first extruder 110 is in a predetermined temperature range from 19° C. to 70° C. In some examples, the solvent has a weight in a range from 5 wt % to 20 wt % of the admixture. In some examples, the temperature of the mixture is maintained in the second extruder 120 in a predetermined temperature range from 70° C. to 150° C. In some examples, the binder is fibrillated in the second extruder 120 greater than 90% (e.g., 100%). Heaters (not shown) can be used to control the temperature of the first extruder 110 and/or the second extruder 120.

Referring now to FIG. 4, another stepwise extrusion process using a single extruder is shown. An extruder 210 includes a screw 212 rotatably arranged in an enclosure 213. The screw 212 of the extruder 210 rotates within the enclosure 213 to mix and shear the dry powder and to stepwise fibrillate the binder. A die 214 such as a slotted die is arranged at an outlet of the extruder 210.

A dry powder 220 including an anode or cathode active material, a conductive filler, and a binder is fed to an inlet 224 of a first portion of the extruder 210. The dry powder is mixed and the binder is partially fibrillated in the first portion. A first liquid feed 230 feeds solvent to a second inlet 234 in a second portion of the extruder 210. The admixture is mixed/sheared and the binder is further fibrillated in the second portion of the extruder 210. A second liquid feed 240 feeds solvent to a second inlet 234 in a third portion of the extruder 210. The admixture is mixed/sheared and the binder is further fibrillated in the third portion of the extruder 210. The die 214 of the extruder 210 outputs an active material layer 250 as a self-standing film or the active material layer 250 is output onto a supporting film 262 supplied by a roll 260.

In some examples, the first solvent is selected from a group consisting of alcohol, ester, and combinations thereof. The first solvent comprises 5 wt % to 10 wt % of the admixture in the second portion of the extruder 210. The second solvent is selected from a group consisting of alcohol, ester, and combinations thereof. In some examples, the first and second solvent are the same. The second solvent comprises 5 wt % to 10 wt % of the admixture in the third portion of the extruder 210.

The binder is fibrillated in a stepwise fashion. In other words, the binder is successively fibrillated in the portions of the extruder 210. In some examples, the binder is partially fibrillated in a range from 20% to 40% in the first portion of the extruder 210. The binder is partially fibrillated in a range from 60% to 80% in the second portion of the extruder 210. The binder is fibrillated greater than 90% (e.g., 100%) in the third portion of the extruder 210. In some examples, a temperature of the admixture in the extruder 210 is greater than 70° C. and less than 150° C. A heater (not shown) can be used to control the temperature of the extruder 210.

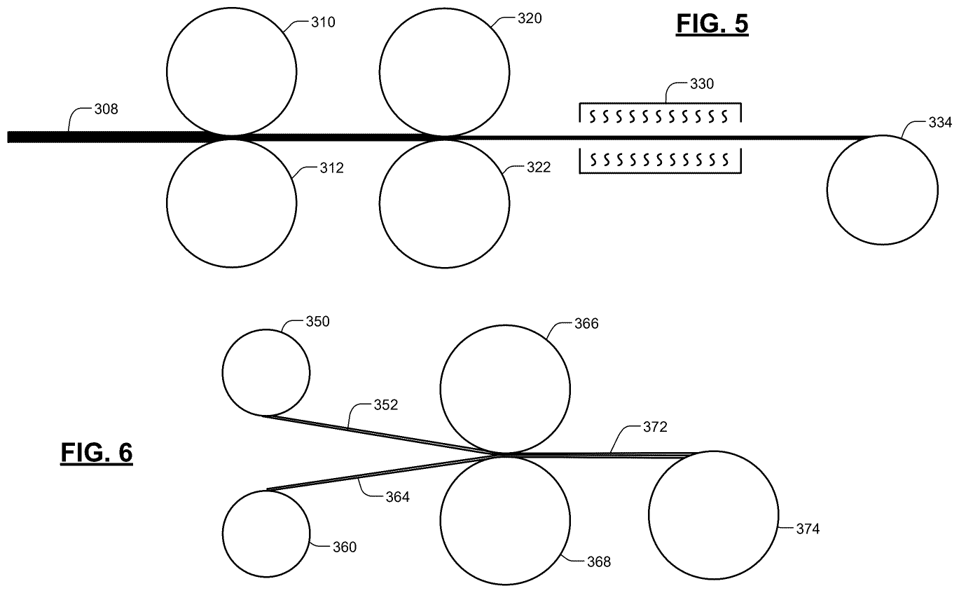

Referring now to FIG. 5, in some examples the active material layers 160/250 pass through a first set of rollers 310 and 312 and a second set of rollers 320 and 322 to reduce a thickness of the film. After rolling and pressing, the active material layer is heated in an oven 330 to a temperature in a range from 19° C. to 150° C. and collected on a roll 334. In some examples, the active material layers 160/250 are heated to a temperature in a range from 80° C. to 100° C.

Referring now to FIG. 6, a roll 350 supplies an active material layer 352 between rollers 366 and 368. The roll 360 supplies a current collector 364 between the rollers 366 and 368. The rollers 366 and 368 press and/or heat the active material layer 352 and the current collector 364 to form an electrode 372 (collected on roll 374). In some examples, a heat sensitive adhesive can be applied on one or both facing surfaces to attach the active material layer 352 and the current collector 364.

In some examples, the binder is selected from a group consisting of polytetrafluoroethylene (PTFE), fluorinated ethylene propylene (FEP), perfluoroalkoxy alkane (PFA), ethylene tetrafluoroethylene (ETFE), polyethylene (PE), or combinations thereof. In some examples, the particle size of the binder is in a range from 1 μm to 1000 μm. In some examples, the particle size of the binder is in a range from 100 μm to 170 μm (e.g., 110 μm or 150 μm). In some examples, the particle size of the binder is in a range from 1 μm to 50 μm.

In some examples, the solid content of the admixture is in a range from 75 to 95wt %. In some examples, the solid content of the admixture is in a range from 80 to 90wt %.

In some examples, the solvent is selected from a group consisting of alcohol, ester, and combinations thereof. In some examples, the solvent is manufacturing friendly. In some examples, the solvent comprises 5 to 40% at mass ratio. In some examples, the solvent is added twice to the extruder 210 in FIG. 4 with either equal or unequal portions.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed. ” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is

1. A method for manufacturing a cathode electrode of a battery cell, comprising:
providing a dry powder mixture including an active material, a conductive additive, and a binder to a first extruder;
mixing the active material, the conductive additive, and the binder in the first extruder;
partially fibrillating the binder in the first extruder;
supplying an admixture from the first extruder to a first input of a second extruder;
supplying a solvent to a second input of the second extruder;
mixing the active material, the conductive additive, the binder, and the solvent in the second extruder;
fibrillating the binder in the second extruder; and
forming an active material layer using an extrudate die arranged at an output of the second extruder.

2. The method of claim 1, wherein:
a first temperature of the first extruder is in a range from 19° C. to 70° C., and a second temperature of the second extruder is greater than 70° C.

3. The method of claim 1, wherein:
the binder is selected from a group consisting of polytetrafluoroethylene (PTFE), fluorinated ethylene propylene (FEP), perfluoroalkoxy alkane (PFA), ethylene tetrafluoroethylene (ETFE), polyethylene (PE), and combinations thereof, and
a particle size of the binder is in a range from 1 μm to 1000 μm.

4. The method of claim 3, wherein a particle size of the binder is in a range from 1 μm to 50 μm.

5. The method of claim 1, wherein:
the solvent is selected from a group consisting of alcohol, ester, and combinations thereof, and
the solvent comprises 5 wt % to 20 wt % of the admixture.

6. The method of claim 1, wherein:
partially fibrillating the binder in the first extruder comprises fibrillating the binder in a range from 10% to 40%, and
fibrillating the binder in the second extruder comprises fibrillating the binder greater than 90%.

7. The method of claim 2, wherein the second temperature of the admixture in the second extruder is less than 150° C.

8. The method of claim 1, further comprising outputting the active material layer onto a supporting film.

9. The method of claim 1, further comprising outputting the active material layer as a freestanding film.

10. The method of claim 1, further comprising:
pressing and heating the active material layer; and
laminating the active material layer onto a current collector.

11. A method for manufacturing a cathode electrode of a battery cell, comprising:
providing a dry powder mixture including a cathode active material, a conductive additive, and a binder to a first inlet of an extruder;
mixing the cathode active material, the conductive additive, and the binder in a first portion of the extruder;
partially fibrillating the binder in the first portion of the extruder;
supplying a first solvent to a second portion of the extruder;
further partially fibrillating the binder in the second portion of the extruder;
supplying a second solvent to a third portion of the extruder;
fibrillating the binder in the third portion of the extruder; and
forming an active material layer using a slotted die arranged at an output of the third portion of the extruder.

12. The method of claim 11, wherein:
the binder is selected from a group consisting of polytetrafluoroethylene (PTFE), fluorinated ethylene propylene (FEP), perfluoroalkoxy alkane (PFA), ethylene tetrafluoroethylene (ETFE), polyethylene (PE), and/or mixtures thereof, and
a particle size of the binder is in a range from 1 μm to 1000 μm.

13. The method of claim 12, wherein:
the first solvent is selected from a group consisting of alcohol, ester, and combinations thereof, and
the first solvent comprises 5 wt % to 10 wt % of a mixture in the second portion of the extruder.

14. The method of claim 13, wherein:
the second solvent is selected from a group consisting of alcohol, ester, and combinations thereof, and
the second solvent comprises 5 wt % to 10 wt % of a mixture in the third portion of the extruder.

15. The method of claim 12, wherein:
partially fibrillating the binder in the first portion of the extruder comprises fibrillating the binder in a range from 20% to 40%,
partially fibrillating the binder in the second portion of the extruder comprises fibrillating the binder in a range from 60% to 80%, and
fibrillating the binder in the third portion of the extruder comprises fibrillating the binder greater than 90%.

16. The method of claim 12, wherein a temperature of the extruder is greater than 70° C. and less than 150° C.

17. The method of claim 11, further comprising outputting the active material layer onto a supporting film.

18. The method of claim 11, further comprising outputting the active material layer as a freestanding film.

19. The method of claim 11, further comprising pressing and heating the active material layer.

20. The method of claim 11, further comprising laminating the active material layer onto a current collector.
